(19) United States
(12) Patent Application Publication
(10) Pub. No.: US 2019/0093711 A1
(43) Pub. Date: Mar. 28, 2019

(54) POWER TRANSMISSION SHAFT

(71) Applicant: IONES CO., LTD., HWASEONG-SI (KR)

(72) Inventors: MUN KI LEE, SUWON-SI (KR); JAE DEOK KO, SEOUL (KR); KEUM MO KIM, CHEONAN-SI (KR); SOON JONG SONG, SEOUL (KR); JI MAN LEE, SUWON-SI (KR); YOUNG WON CHOI, SEOUL (KR); JEONG CHAN LEE, SEOUL (KR); JIN HO PARK, SEOUL (KR); BYUNG GI KIM, SUWON-SI (KR)

(21) Appl. No.: 15/536,649

(22) PCT Filed: Mar. 2, 2015
(86) PCT No.: PCT/KR2015/001987

§ 371 Date: Jun. 16, 2017

(30) Foreign Application Priority Data
Dec. 30, 2014 (KR) 10-2014-0193163

(51) Int. Cl. F16D 9/10; F16D 3/78; F16C 3/02

(52) U.S. Cl. CPC F16D 9/10; F16D 3/78; F16C 11/06; F16C 2326/43; F16C 3/02

(57) ABSTRACT

A power transmission shaft performs a fuse-like function when excessive torque is applied to a power input side. The power transmission shaft includes: a main shaft connected to a power device; flanges connected to the power device and provided at both sides of the main shaft; and a flexible coupling extending in the radial direction of the main shaft. The power transmission shaft includes a power shutoff unit which shuts off power by breaking the main shaft or the flanges when torque greater than a predetermined level is applied. When excessive torque is applied to the power input side, the power transmission shaft performs a fuse-like function with respect to the excessive torque, thereby enhancing safety, preventing sparks from occurring at the time of the breakage, facilitating the production thereof, and effectively preventing vibration while sufficiently supporting the speed or load in the event of a high rotation rate.

### TECHNICAL FIELD

The present invention relates to a power transmission shaft, and more particularly, to a power transmission shaft which is connected between an engine and a gear box of an aircraft to transmit power.

### BACKGROUND ART

In general, a coupling is a shaft connection device for connecting a driven shaft to a driving shaft, and there are various couplings, such as fluid couplings, gear couplings, flexible couplings, and so on, according to their types. Moreover, a user selects a coupling of a proper type in consideration of an optimal torque range, torsional strength, eccentric error absorption, proper number of revolutions, and so on according to use purposes.

As an example, in the case of aircrafts, a power transmission shaft is mounted between an engine and a gear box to transmit power of the engine to the gear box. In this instance, because vibration and shock are generated due to the nature of aircrafts, a flexible coupling is used in order to absorb such vibration and shock and continuously transmit power of the engine to the gear box even though an axial center becomes eccentric among the engine, the power transmission shaft and the gear box. Such a flexible coupling is rigid in the rotational direction but is soft in the axial direction.

U.S. Pat. No. 4,802,882 discloses a flexible coupling. The conventional flexible coupling includes a first joint part connected with a power transmission shaft, a second joint part connected with a device (an engine or a gear box), and a diaphragm arranged between the first joint part and the second joint part to connect the first joint part and the second joint part with each other in a communicating manner.

The diaphragm has a plurality of diaphragm members mounted between the first joint part and the second joint part to connect the first and second joint parts to communicate with each other in an axial direction. The flexible coupling can absorb vibration and shock generated from an aircraft and transmit power of the engine to the gear box even though an axial center becomes eccentric among the engine, the power transmission shaft and the gear box.

FIG. 1 is a sectional view showing a conventional power transmission shaft.

As shown in FIG. 1, the conventional power transmission shaft 1 includes a main shaft 13, and flanges 11 disposed at both sides of the main shaft 13 and connected with an engine or a gear box. Flexible couplings 12 are respectively disposed at the rear ends of the flanges 11, and are assembled to the flange 11 and the main shaft 13 by welding. The flexible couplings 12 serves to compensate the phenomenon that axes of the engine and the gear box do not match with each other.

The flexible coupling 12 is a contoured diaphragm assembly, and is configured not to be fatigue-destroyed during a desired lifespan. The power transmission shaft 1 an anti-flailing device in order to prevent whirling or whipping when the flexible coupling 12 is damaged. If the power transmission shaft 1 is fatally damaged in aircraft navigation due to a damage of peripheral devices when the power transmission shaft 1 shakes in the aircraft.

The anti-flailing device may have a ball joint 14. The ball joint 14 restrains axial and radial movements, and serves to allow only a rotary motion at the central portion of the flexible coupling 12. The ball joint 14 compensates the axial discordance between the engine and the gear box as much as the rotated angle. The ball joint 14 includes a ball which is lubricative and has a hole formed at the center, and a housing restraining the ball. The housing is fixed to the flange 11 via a bolt. The main shaft 13 is connected with the central holes of the ball joints 14 to prevent the whirling by restraining the axial and radial movements.

As described above, the conventional power transmission shaft transmits power between the aircraft engine and the gear box. If there is no safety device when excessive torque is applied to the gear box, the engine is damaged. An aircraft can fly for about 15 minutes without an auxiliary power unit (APU), but promptly crashes when having some engine trouble. Therefore, if there is no torque restriction device in the gear box, the power transmission shaft must function as a fuse against torque in order to protect the engine.

### DISCLOSURE

### Technical Problem

Accordingly, the present invention has been made in view of the above-mentioned problems occurring in the prior art, and it is an object of the present invention to provide a power transmission shaft which can function as a fuse against excessive torque.

It is another object of the present invention to provide a power transmission shaft with an improved structure which can sufficiently support speed or load and effectively prevent whirling at high rotation speed.

### Technical Solution

To accomplish the above object, according to the present invention, there is provided a power transmission shaft including: a main shaft for connecting a power unit; flanges disposed at both sides of the main shaft to be joined with the power unit; a flexible coupling formed to extend in a radial direction of the main shaft; and a power shutoff unit formed at least one of the main shaft and the flange in order to cut off power by breaking the main shaft or the flange when torque greater than a predetermined level is applied.

### Advantageous Effects

As described above, the power transmission shaft according to an embodiment of the present invention can function as a fuse against excessive torque when there is excessive torque applied to a power input side, thereby improving safety, preventing sparking when the flange or the shaft is broken, allowing easy machining, and sufficiently supporting speed or load and effectively preventing whirling at high rotation speed.

### DESCRIPTION OF DRAWINGS

FIG. 1 is a sectional view showing a conventional power transmission shaft.

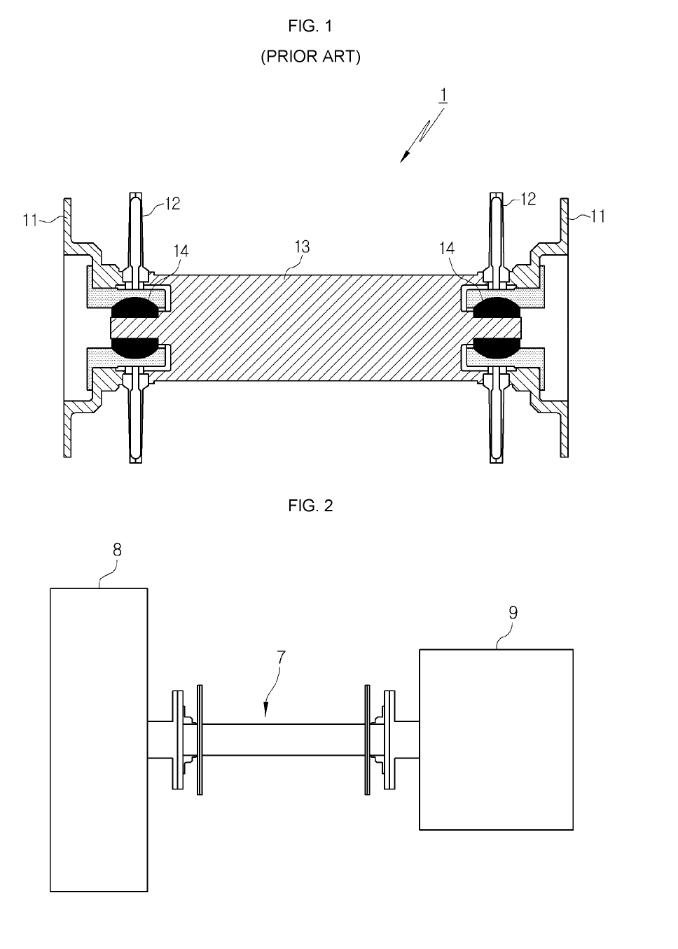

FIG. 2 is a front view schematically showing a power transmission shaft according to a first preferred embodiment of the present invention.

FIG. 3 is a sectional view of the power transmission shaft according to the first preferred embodiment of the present invention.

FIG. 4 is a sectional view of a power transmission shaft according to a second preferred embodiment of the present invention.

FIG. 5 is a sectional view of a power transmission shaft according to a modification of FIG. 4.

FIGS. 6 and 7 are sectional views of power transmission shafts according to modifications of FIG. 4.

FIG. 8 is a sectional view of a power transmission shaft according to a third preferred embodiment of the present invention.

### MODE FOR INVENTION

Hereinafter, reference will be now made in detail to the technical construction of a power transmission shaft with reference to the attached drawings.

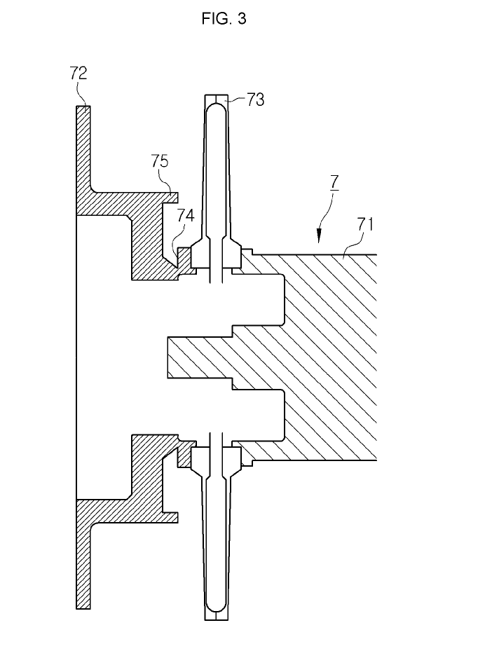

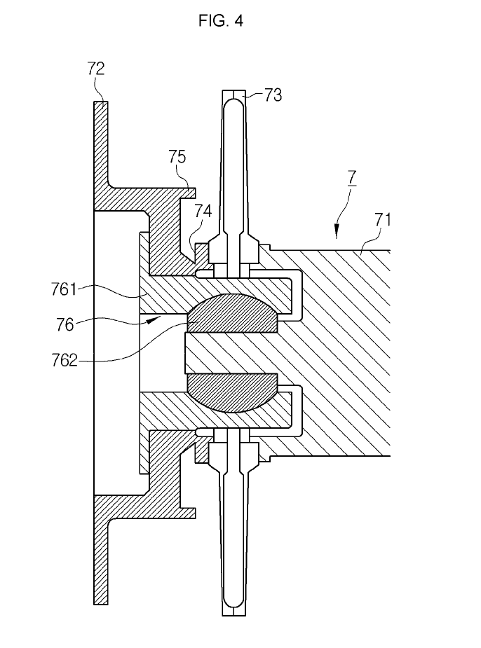

FIG. 2 is a front view schematically showing a power transmission shaft according to a first preferred embodiment of the present invention, and FIG. 3 is a sectional view of the power transmission shaft according to the first preferred embodiment of the present invention.

In the following description, the lateral direction of FIG. 3 is an “axial direction” and the vertical direction is a “radial direction”.

As shown in FIGS. 2 and 3, the power transmission shaft 7 according to the first preferred embodiment of the present invention connects an engine 8 and a gear box 9 of an aircraft with each other to transmit power. The power transmission shaft 7 includes: a main shaft 71 for connecting a power unit; flanges 72 disposed at both sides of the main shaft 71 to be joined with the power unit; and a coupling 73 formed to extend in a radial direction of the main shaft 71.

Moreover, the power transmission shaft 7 includes a power shutoff unit. The power shutoff unit is formed at least one of the main shaft 71 and the flange 72, in order to cut off the power by breaking the main shaft 71 or the flange 72 when torque over certain level is applied.

The power shutoff unit has a notch 74. The notch 74 is formed on the outer circumferential surface of at least one of the main shaft 71 and the flange 72, and is dented inwardly in the radial direction. The notch 74 is formed to get inwardly narrower from the outside in the radial direction, and is generally formed in the shape of “V”.

When excessive load (torque) is applied to the gear box 9 of an auxiliary power unit (APU) in a moment, the notch 74 is artificially formed between a diaphragm of the flexible coupling 73 and the surface of the flange in order to break the minimum area by a shearing force. It is possible to predict breakage torque according to arithmetic operation by applying depth or the minimum rib thickness of the notch 74, and is also possible to design in a desired form by reflecting demands.

Furthermore, the power transmission shaft 7 further includes a screen 75. The screen 75 is formed on the outside in the radial direction relative to the notch 74 and covers at least a part of the notch 74 to prevent scattering of sparks. A part of the screen 75 is opened outwardly in the radial direction. When a part of the screen 75 is opened, it makes machining possible and lowers manufacturing costs. In this instance, the opened part of the screen 75 faces the flexible coupling 73 to prevent sparks from directly getting out.

The notch 74 is formed in at least one of a power input side and a power output side. In this embodiment, the notch 74 is formed in the flange 72 and is arranged in the power input side.

Additionally, the notch 74 is inclined in one direction to get deeper toward the flexible coupling 73, and the screen 75 is formed to extend toward the flexible coupling 73. Such a configuration is formed in consideration of machining accuracy, possibility of machining and machining easiness due to the nature of the power transmission shaft for aircrafts.

In other words, the flexible coupling 73 is formed at the center, the notch 74 is formed at the left or the right relative to the flexible coupling 73, and the screen 75 appropriate to the notch is formed to protect the notch 74. In addition, considering machinability, the notch is inclined so as to be opened just toward the flexible coupling 73.

Moreover, because the notch 74 is structurally weak, the screen 75 is formed to protect the notch from a direct external damage and to allow just transmission destruction by excessive torque. Furthermore, the screen 75 is used as means for preventing sparks.

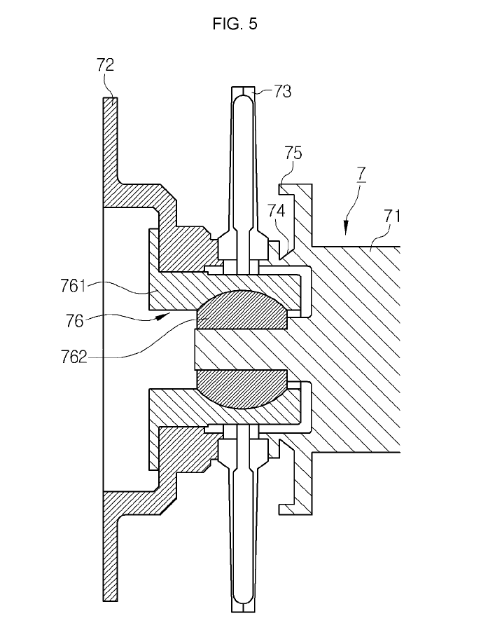

FIG. 4 is a sectional view of a power transmission shaft according to a second preferred embodiment of the present invention. Compared with the first embodiment illustrated in FIG. 3, the power transmission shaft according to the second preferred embodiment illustrated in FIG. 4 further includes a ball joint, and in the second preferred embodiment, description of repeated structure will be omitted.

Referring to FIG. 4, the power transmission shaft 7 includes a ball joint 76. The ball joint 76 is disposed between the main shaft 71 and the flange 72 to prevent whirling of the main shaft 71. The ball joint 76 restricts axial and radial direction movements and allows rotational direction movements of between the main shaft 71 and the flange 72 in the rotational direction. The ball joint 76 is fixed at the side of the flange 72. Additionally, a lubricant is disposed on a rotating part of the ball joint 76.

The ball joint 76 includes a ball 762 which is lubricative and has a hole at the center, and a housing 761 for restricting the ball 762. The housing 761 is fixed at the flange 72 via a bolt or the like. The main shaft 71 is connected with a central hole of the ball joint 76 to restrict axial and radial direction movements, thereby preventing an axial whirling. In this embodiment, the ball joint 76 may be a sleeve bearing.

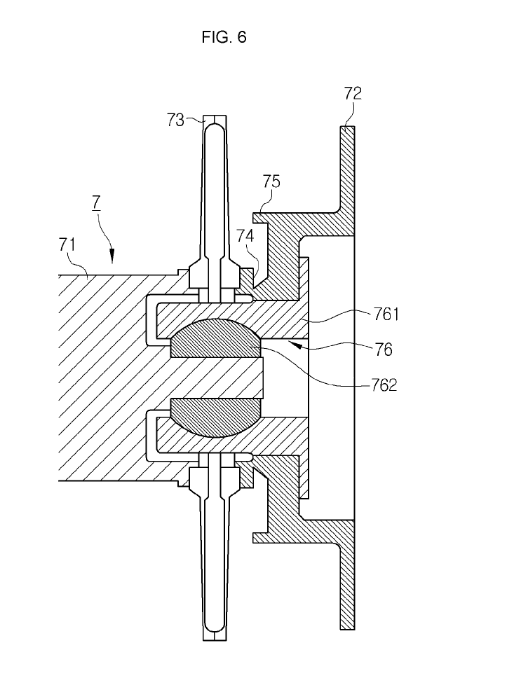

FIG. 5 is a sectional view of a power transmission shaft according to a modification of FIG. 4. Compared with the embodiment illustrated in FIG. 4, the power transmission shaft according to the embodiment illustrated in FIG. 5 has a notch formed in the main shaft, and in the second preferred embodiment, description of repeated structure will be omitted.

Referring to FIG. 5, the notch 74 is formed on the outer circumferential surface of the main shaft 71 to be inwardly dented in the radial direction. In this instance, the screen 75 extends in the radial direction from the outer circumferential surface of the main shaft 71, and extends again in the axial direction from the extended end portion to cover the notch 74. Functions of the notch 74 and the screen 75 are the same as the previously mentioned embodiments.

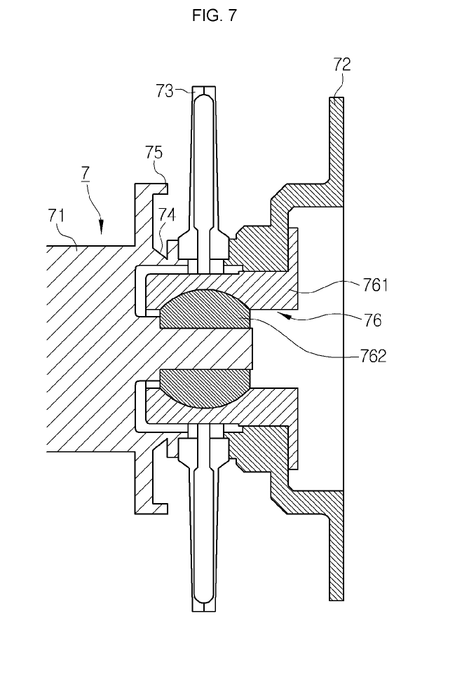

In the meantime, FIGS. 6 and 7 are sectional views of power transmission shafts according to modifications of FIG. 4. As shown in FIGS. 6 and 7, notchs 74 may be respectively formed not only in the power input side but also in the power output side. If necessary, the notches 74 may be formed in all of the power input side and the power output side. As described above, the depth and location of the notch 74 may be changed properly.

Referring to FIG. 3, when the notch 74 of the flange 72 is cut, the flange of the engine 8 rotates, and the opposite side is stopped in rotation. In this instance, if axes of the engine 8 and the gear box 9 do not match with each other, the axes cross with each other relative to the ball of the ball joint. In this instance, a rotating side and a stopping side of a cut surface get in contact, so that a force that the rotating side rotates the stopping side by friction is generated.

In this instance, when rotation by friction is not achieved due to excessive torque of the stopping side, it causes a relative motion and also causes sparks by friction. When sparks fly in all directions, it may cause fire at an oily place of peripheral devices. The screen 75 is disposed on the outer surface of the notch 74 to prevent such sparks.

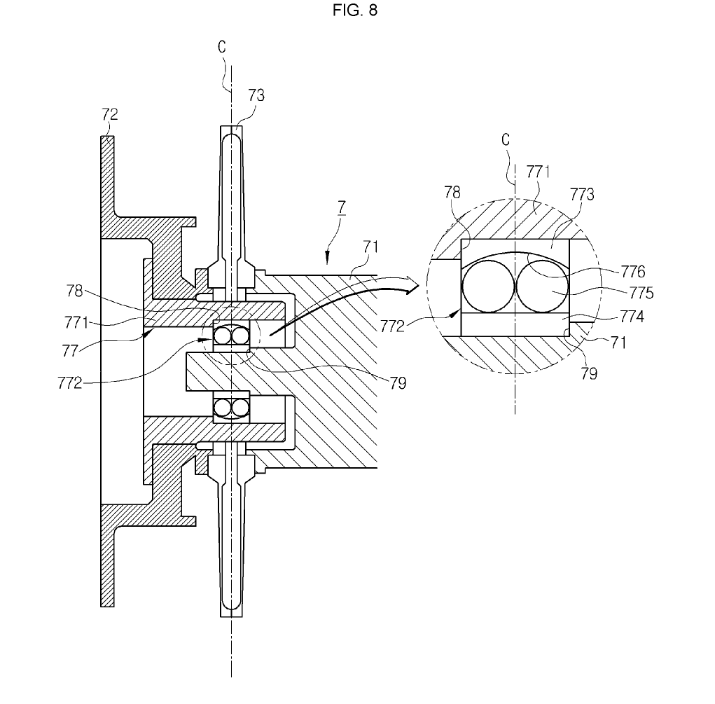

In the meantime, FIG. 8 is a sectional view of a power transmission shaft according to a third preferred embodiment of the present invention.

Referring to FIG. 8, the power transmission shaft 7 according to the third preferred embodiment of the present invention includes a main shaft 71 for connecting a power unit, flanges 72 disposed at both sides of the main shaft 71 and joined with the power unit, and a flexible coupling 73 formed to extend in the radial direction of the main shaft 71. Moreover, the power transmission shaft 7 further includes a ball joint.

The ball joint may be a ball bearing 77. The ball bearing 77 is disposed between the main shaft 71 and the flange 72 to prevent whirling of the main shaft 71. The ball bearing 77 restricts axial and radial direction movements and allows rotational direction movements. The ball bearing 77 includes a housing 771 fixed at the flange 72, and a plurality of balls 772 interposed between the housing 771 and the main shaft 71.

The ball bearing 77 is in a point contact when rotating, and is optimized in a relatively high speed environment. The ball bearing 77 is more advantageous in the relatively high speed environment than the sleeve bearing when the power transmission shaft rotates at high speed.

The ball bearing 77 includes a housing 771 fixed at the flange 72 and a bearing 772 disposed between the housing 771 and the main shaft 71. The bearing 772 includes an outer wheel 773, an inner wheel 774 and a ball 775. The outer wheel 773 comes into contact with the housing 771, the inner wheel 774 comes into contact with the main shaft 71, and the ball 775 is disposed between the outer wheel 773 and the inner wheel 774.

The inner surface of the outer wheel 773 is formed in the shape of a sphere 776, and the center of the bearing 772 coincides with a central line C of the flexible coupling 73 along the axial direction. Therefore, the bearing 772 may do self-aligning. Additionally, the flexible coupling 73 can be rotated (bent) relative to the center of the ball bearing 77 and restricted in the axial direction by the spherical surface of the outer wheel 773.

Furthermore, stepped portions 78 and 79 may be respectively formed on one side of the housing 771 and one side of the main shaft 71 so that pre-load is applied when the housing 771 of the ball bearing 77 is joined in the axial direction.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be defined by the scope of the appended claims.

1-12. (canceled)

13. A power transmission shaft comprising a main shaft to connect a power unit; flanges disposed at both sides of the main shaft to be joined with the power unit; a flexible coupling formed to extend in a radial direction of the main shaft; and a power shutoff unit formed at least one of the main shaft and the flanges to cut off power by breaking the main shaft or the flanges in response to an application of a torque greater than a predetermined level.

14. The power transmission shaft according to claim 13, wherein the power shutoff unit is formed on an outer circumferential surface of at least one of the main shaft and the flanges, and comprising a notch dented inwardly in the radial direction.

15. The power transmission shaft according to claim 14, further comprising a screen formed on an outer surface in the radial direction relative to the notch to cover at least a part of the notch and prevent scattering of sparks.

16. The power transmission shaft according to claim 15, wherein a part of the screen is opened outwardly in the radial direction.

17. The power transmission shaft according to claim 16, wherein the opened part of the screen faces toward the flexible coupling.

18. The power transmission shaft according to claim 14, wherein the notch is formed in at least one of a power input side and a power output side.

19. The power transmission shaft according to claim 13, further comprising a ball joint disposed between the main shaft and the flanges to prevent whirling of the main shaft, the ball joint restricts axial and radial direction movements but allows rotational directional movements between the main shaft and the flanges.

20. The power transmission shaft according to claim 19, wherein the ball joint is fixed at the side of the flanges.

21. The power transmission shaft according to claim 19, wherein a lubricant is disposed on a rotating part of the ball joint.

22. A power transmission shaft comprising a main shaft to connect a power unit; flanges disposed at both sides of the main shaft to be joined with the power unit; a flexible coupling formed to extend in a radial direction of the main shaft; and a ball bearing disposed between the main shaft and the flanges to prevent whirling of the main shaft, the ball bearing restricts axial and radial directional movements but allows rotational direction movements between the main shaft and the flanges.

23. The power transmission shaft according to claim 22, wherein the ball bearing comprises a housing fixed to the flanges and a bearing disposed between a housing and the main shaft; and wherein the bearing comprises an outer wheel, an inner wheel and a ball, an inner surface of the outer wheel is formed in a shape of a sphere, and a center of the bearing coincides with a central line of the flexible coupling along an axial direction.

24. The power transmission shaft according to claim 23, further comprising stepped portions respectively formed on one side of the housing and one side of the main shaft so that a pre-load is applied when the housing of the ball bearing is joined in the axial direction.
